(19) United States
(12) Patent Application Publication
(10) Pub. No.: US 2009/0004445 A1
(43) Pub. Date: Jan. 1, 2009

(54) Metallic Ink, and Method for Forming of Electrode Using the Same and Substrate

(75) Inventors: Chang-woo Park, Daejeon-si (KR); Dong-kyu Park, Cheongju (KR)

Correspondence Address: HOLME ROBERTS & OWEN LLP, 1700 LINCOLN STREET, SUITE 4100, DENVER, CO, 80203, US

(73) Assignee: ADVANCED NANO PRODUCTS CO., LTD., Chungwon (KR)

(21) Appl. No.: 12/118,653

(22) Filed: May 9, 2008

Related U.S. Application Data
(63) Continuation of application No. PCT/KR2006/000511, filed on Feb. 14, 2006.

(30) Foreign Application Priority Data
Nov. 9, 2005 (KR) 10-2005-0106881

(51) Int. Cl. B32B 3/10; B05D 5/12; C09D 11/00

(52) U.S. Cl. 428/207; 427/123; 106/31.13; 106/31.92

(57) ABSTRACT

Disclosed is a metallic ink, a method of forming electrodes using the metallic ink, and a substrate using the metallic ink. The metallic ink comprises at least one oxide selected from metal oxide nanoparticles and partially polycondensated metal oxides having a size of 100 nm or less, and metal nanoparticles having a size of 100 nm or less. The oxides and the metal nanoparticles are dispersed as isolated ultrafine particles in solvent. The method comprises patterning the ink using an inkjet printer to form a conductive wire. The substrate is produced through the method. It is thereby possible to conduct patterning using an inkjet printer, and adhesive power to substrates is improved. The metallic ink is useful to produce electrodes of various panels, such as PDPs.

### CROSS-REFERENCE TO RELATED APPLICATIONS

This application claims the benefit of and priority to PCT International Patent Application No. PCT/KR2006/000511, filed Feb. 14, 2006, which claims the benefit of and priority to KR 10-2005-0106881, filed Nov. 9, 2005, both of which are herein incorporated by reference in their entireties.

### BACKGROUND OF THE INVENTION

1. Technical Field

The present invention relates to metallic ink, a method of forming electrodes using the metallic ink, and the substrate using the metallic ink. More particularly, the present invention pertains to a metallic ink which has nano-sized ultrafine metal particles dispersed therein and also has metal oxides and/or partially polycondensated metal oxides in conjunction with the ultrafine metal particles dispersed and contained therein, a method of forming electrodes in which the ink is patterned using an inkjet printer, and substrates on which the electrodes are formed using the method. Thus, it is possible to conduct the patterning using the inkjet printer, and the metallic ink has significantly improved adhesive power to substrates.

2. The Relevant Technology

In accordance with advances in the electronics industry, application fields of metal are gradually becoming diversified. Particularly, fine metal powder is frequently used to realize a metallic texture or to form conductive wires.

For example, it is extensively considered preferable that appearances of various plastic electronic products, such as mobile communication terminals and home appliances, have a metallic color, thus metal powder is contained in a pigment to be used for coating. Particularly, since a silver-based metallic color gives products a sophisticated and smart appearance, silver (Ag) is frequently used to obtain a richer appearance.

Furthermore, since metal has excellent conductivity, it is fabricates as paste form and printed on substrates, such as plastic or glass, to form a conductive wire, thus being applicable to the production of various electrode substrates used in PDPs (plasma display panels). In this conventional silver paste, the metal with a size of a few micrometer to a few tens of micrometers has been used for application. The metal powder is mixed with an organic binder, such as a photosensitive epoxy resin, to form paste and then printed on a matrix using a silk screen method or a lithography method. An example of the printing process for PDP application is described as follow. First, the metal paste composition is screen printed on a surface of a glass substrate (matrix) to form a film. Additionally, the film is micropatterned using a lithography method to form a fine conductive wire on the substrate. Subsequently, organics are burned out at a high temperature over 500° C. to create a substrate for electrodes, on which the conductive wire is patterned.

However, in the above-mentioned process, equipments are large and the process is complicated; thus, recently, efforts have been made to adopt a printing process using an inkjet printer. The printing process using the inkjet printer is advantageous in that printing speed is high, relatively simple equipment is used, and shapes of patterns to be printed are unlimited. Furthermore, it is possible to freely form printed wires having various thicknesses, that is, fine wires and thick wires, and the process is simple, thus it is possible to reduce production cost and to reform the production process. Due to the above advantages, it is expected that the inkjet printing process substitutes for the screen printing process or the lithography process.

In connection with this, a metallic ink, used in the inkjet printer, must satisfy desirable characteristics of an inkjet ink so as to prevent a nozzle from being clogged. It is necessary to keep the nanosized metal particles with excellent dispersity with no or minimum agglomeration.

Recently, in order to introduce a printing process using inkjet technology, a solution, which includes silver particles having a size less than 100 nm dispersed therein, has been developed and applied to produce a PDP, and many studies thereof have been made. Studies of the production of ultrafine metal particles having excellent dispersity have continuously been reported in many documents and patents, such as Langmuir, 1996, 12, 4723; Chem. Rev. 2004, 104, 3893; J. Phys. Chem. B., 1988, 102, 8378; J. Am. Chem. Soc. 1999, 121, 882; J. Phys. Chem. B., 1999, 103, 5488; and Korean Patent Laid-Open Publication No. 10-2002-7007534, since the 1980s. The production process may roughly be classified into a chemical reduction process using reducing agents and a gas vaporization process in which metal is vaporized in a gas phase and then condensed. The ultrafine metal particles thus produced are agitated in conjunction with solvents, resins, and dispersing agents, exposed to an ultrasonic wave, dispersed and treated using a ball mill or a sand mill to produce an ultrafine metal particle-dispersed solution.

As an example of such metallic inks (ultrafine metal particle-dispersed solution) that has high concentration and low viscosity, silver ink with excellent conductivity is most useful to form electrodes through inkjet patterning of PDPs or other displays.

Furthermore, Korean Patent Laid-Open Publication No. 10-2002-0074167 discloses an ink which satisfies desirable characteristics of an inkjet ink and comprises an ultrafine metal particle-dispersed solution, and a method of producing the same. Additionally, Korean Patent Laid-Open Publication No. 10-2002-0080393 discloses a use of the ink described in the former patent, and a method of forming electrodes of a flat panel display using an inkjet printer.

However, the conventional ultrafine metal particle-dispersed solution (metallic ink) is problematic in that it has very low adhesive power to substrate. The surface of nano-sized metal particles is chemically unstable, thus is easily denatured in the air. Accordingly, the color of patterned conductive wire is changed over time, and, particularly, its adhesive power is rapidly reduced. If the adhesive power is reduced, the conductive metal wire is easily peeled off, causing a fatal defect in the electrodes. Hence, it is impossible to apply the metallic ink to PDP process.

Generally, the metallic pattern formed with silver metallic ink loses conductivity as well as adhesive power to the substrates due to the evaporation of the ultrafine silver metal particles in it upon heat treatment at over 450° C., and thus this becomes another reason that the conventional silver metallic ink is not suitable for the processes requiring high temperature sintering over 450° C., such as in PDP applications.

### BRIEF SUMMARY OF THE INVENTION

### Technical Problem

In view of the foregoing, a metallic ink, having a nano-sized metal dispersed therewithin, that can be used in an inkjet printer at lower cost with improved productivity has been sought. However, unless the adhesion power of the ink to substrates after inkjet patterning is improved drastically, it is impractical to use conventional inkjet metallic inks for commercial purposes.

Accordingly, the present invention has been made keeping in mind the above problems occurring in the prior art, and an object of the present invention is to provide a metallic ink which comprises means for improving adhesive power to substrates, a method of forming electrodes and a substrate using the metallic ink.

Another object of the present invention is to provide a metallic ink which is not vaporized when it is heat treated at high temperatures and has improved adhesive power and conductivity, a method of forming electrodes using the metallic ink, and a substrate using the metallic ink.

### Solution to Problem

In order to accomplish the above objects, the present invention provides a metallic ink, which comprises at least one oxide selected from metal oxide nanoparticles and partially polycondensateded metal oxides having a size of 100 nm or less, and metal nanoparticles having a size of 100 nm or less. The oxides and the metal nanoparticles are dispersed as completely isolated particles in solvent.

Furthermore, the present invention provides a metallic ink which comprises metal nanoparticles which have a size of 100 nm or less and are dispersed as completely isolated particles in solvent. The metal nanoparticles are an alloy of a first metal, having conductivity higher than that of a second metal, and the second metal, which forms the alloy along with the first metal to provide thermal stability, or a mixture of first and second metal particles.

Additionally, the present invention provides a method of forming electrodes. The method comprises producing a metallic ink which includes at least one oxide selected from metal oxide nanoparticles and partially polycondensated metal oxides having a size of 100 nm or less, and metal nanoparticles having a size of 100 nm or less, patterning the metallic ink on substrates using an inkjet printer, and heat treating the patterned metallic ink. The oxides and the metal nanoparticles are dispersed as completely isolated particles in solvent.

As well, the present invention provides a method of forming electrodes. The method comprises producing a metallic ink including metal nanoparticles which have a size of 100 nm or less and are dispersed in solvent, patterning the metallic ink on a substrate using an inkjet printer, and heat treating the patterned metallic ink. The metal nanoparticles are either the mixture of the first and second metal or alloy of the first and the second metal where the first metal has conductivity higher than that of second metal and the second metal forms the alloy along with the first metal to provide thermal stability. Heat treatment is conducted at 60° C. or higher, and preferably at 450° C. or higher, so as to obtain excellent conductivity, adhesive power, and strength.

Furthermore, the present invention provides a substrate, on which electrodes are formed through the method mentioned above.

According to the present invention, adhesive power to substrates is improved due to metal oxides and partially polycondensated metal oxides. Furthermore, if metal nanoparticles include an alloy, vaporization upon high temperature treatment is avoided, thus it is possible to conduct heat treatment at high temperatures, thereby improving adhesive power and conductivity.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 shows a particle size distribution of an Ag/Pd nanoparticles dispersed in solution;

FIG. 2 is a TEM picture of the Ag/Pd nanoparticles.

FIG. 3 is a picture showing Ag/Pd metal wires formed through inkjet patterning;

FIG. 4 is a SEM picture of a metal wire heat treated at 250° C.; and

FIG. 5 is a SEM picture of a metal wire heat treated at 560° C.

### DETAILED DESCRIPTION OF THE PREFERRED EMBODIMENTS

The present inventors have conducted studies into avoidance of problems of a conventional metallic ink, such as reduction in adhesive power and fatal defects in patterned metal wires caused by vaporization of metal when it is heat treated at high temperatures. From the studies, the present inventors found the following fact, thereby accomplishing the present invention. The metal nanoparticles dispersed as completely isolated particles in solvent offers the fluidity required in an inkjet process, and physical properties of ink are excellent. If metal oxide nanoparticles and/or partial polycondensated metal oxides are dispersed as completely isolated particles in solvent along with metal nanoparticles, adhesive power after patterning is significantly improved. Furthermore, if the metal nanoparticles comprise an alloy so that the alloy comprises a first metal, having desirable conductivity, and a second metal, which has conductivity inferior to that of the first metal and which forms the alloy along with the first metal to provide thermal stability, vaporization does not occur during high-temperature treatment, and adhesive power and conductivity are improved due to the high-temperature treatment.

A metallic ink according to a first aspect of the present invention comprises A) the metal oxide nanoparticles, and/or B) the partially polycondensated metal oxides, C) the metal nanoparticles, and D) a dispersing solvent.

Furthermore, in a metallic ink according to a second aspect of the present invention, metal nanoparticles are dispersed as completely isolated particles in solvent as an alloy or mixture of metals. The metallic ink comprises C) the metal nanoparticles and D) a dispersing solvent. The metal nanoparticles are either the mixture of first and second metal particles or the alloy comprises a first metal with high conductivity and a second metal which forms an alloy along with the first metal to provide thermal stability.

The metallic inks according to the first and second aspects of the present invention both have excellent adhesive power, satisfying objects of the present invention. In detail, in the first aspect, adhesion to a substrates is improved due to the metal oxide nanoparticles (A) or the partially polycondensated metal oxides (B), thus adhesive power is increased. Additionally, in the second aspect, desirable conductivity required in conductive wires is assured due to the first metal, and it is possible to conduct high-temperature treatment after patterning due to the second metal; thus the adhesive power is increased.

The metal oxide nanoparticle (A) has a size of 100 nm or less, particularly, 1-100 nm. Preferably, the size is 50 nm or less so as to optimally conduct inkjet discharge. In connection with this, if the size of the metal oxide nanoparticle (A) is more than 100 nm, undesirably, a nozzle of an inkjet printer may be clogged.

Any type of metal oxide nanoparticle (A) may be used in the present invention as long as it is capable of providing desirable contact to the matrix. The metal oxide nanoparticle (A) may be any one or a mixture of two or more selected from the group consisting of oxides of silicon (Si), magnesium (Mg), yttrium (Y), cerium (Ce), titanium (Ti), zirconium (Zr), vanadium (V), chromium (Cr), manganese (Mn), iron (Fe), cobalt (Co), nickel (Ni), neodymium (Nd), copper (Cu), silver (Ag), zinc (Zn), aluminum (Al), gallium (Ga), indium (In), tin (Sn), and antimony (Sb). In detail, it may be any one or a mixture of two or more selected from the group consisting of silicon oxide (SiO 2, silica), tin oxide (SnO 2), indium oxide (In 2 O 3), titanium oxide (TiO 2), zinc oxide (ZnO), antimony oxide (Sb O), magnesium oxide (MgO), calcium oxide (CaO), and iron oxide (FeO). Furthermore, it is dispersed in a solvent in a size of 100 nm or less for application.

Any type of partial polycondensation metal oxide (B) may be used as long as it can provide desirable contact to the substrates. For example, it is one or more selected from metal alkoxides shown in the following Formula 1, or a poly condensate produced by hydrolyzing and condensing one or more selected from the metal alkoxides.

M(OR)ₙ Formula 1

(wherein, M is any one selected from the group consisting of Si, Sn, In, Ti, Zn, Mg, Ca, and Sb, R is hydrogen or hydrocarbon having various functional groups (an alkyl group, an aryl group, or the like), and n is an integer ranging from 1 to 10)

Furthermore, the partial polycondensation metal oxide (B) may be an inorganic polycondensation polymer disclosed in the following Formula 2.

M_{X}O_{Y}(OR)_{Z} Formula 2

(wherein, M is any one selected from the group consisting of Si, Mg, Y, Ce, Ti, Zr, V, Cr, Mn, Fe, Co, Ni, Nd, Cu, Ag, Zn, Al, Ga, In, Sn, and Sb, R is hydrogen or hydrocarbon having various functional groups (an alkyl group, an aryl group, or the like), and x, y, and z are integers or decimals larger than 0).

It is preferable that the metallic ink of the present invention comprise 0.01-30% metal oxide nanoparticles (A) and/or partial polycondensation metal oxides (B) based on a total weight of solids. In detail, A and/or B (A, B, or A+B) are 0.01-30 wt % based on all solids (A+B+C, A+C or B+C) containing the metal oxide nanoparticles (A). Preferably, it is 0.1-10%. In connection with this, if a weight ratio of metal oxide nanoparticles (A) and/or partial polycondensation metal oxides (B) to the metal nanoparticles (C) is excessively high, the adhesive power is increased, but conductivity of a conductive wire patterned through an inkjet process is reduced. If the ratio is very low, it is difficult to obtain adequate adhesive power.

The metal nanoparticle (C) has a size of 100 nm or less, particularly, 1-100 nm. For example, the metal nanoparticle (C) may be one or more selected from the group consisting of silver (Ag), gold (Au), platinum (Pt), copper (Cu), palladium (Pd), and nickel (Ni). Preferably, it is an alloy or mixture of two or more metals.

As well, it is preferable that the metal nanoparticle (C) comprise a metal having relatively high conductivity (first metal) and another metal (second metal), which has conductivity inferior to the first metal and forms an alloy along with the first metal to provide thermal stability, if the metal nanoparticle (C) is the alloy. Furthermore, if it is the mixture of two or more, it preferably comprises a first metal, having relatively high conductivity, and a second metal, which forms an alloy along with the first metal to provide thermal stability. In connection with this, the first metal may be any one selected from the group consisting of silver (Ag), gold (Au), platinum (Pt), and copper (Cu), and the second metal may be any one selected from the group consisting of palladium (Pd) and nickel (Ni).

The metal nanoparticle (C) according to a preferred embodiment of the present invention may be an alloy including at least silver (Ag) having excellent conductivity and reasonable price, and more preferably, an alloy (Ag/Pd alloy) including silver (Ag) and palladium (Pd). If the metal nanoparticle (C) is the alloy as described above, nano-sized alloy particles are produced and then dispersed in the ink. Furthermore, if the metal nanoparticles are mixed and dispersed in the ink at a predetermined ratio, the ink, including the metal nanoparticles dispersed therein, is inkjet patterned and then forms the alloy during heat treatment.

When the metal nanoparticles (C) include the alloy and when the alloy comprises the first metal having high conductivity and the second metal that forms the alloy along with the first metal to provide thermal stability, it is possible to conduct heat treatment at a high temperature of 450° C. or higher, particularly, 650° C., without vaporization. In other words, it is possible to conduct the high-temperature treatment without the vaporization, and the adhesive power to the matrix is increased due to the high-temperature treatment. The high-temperature treatment contributes to improved conductivity.

For example, if the metal nanoparticles (C) are the Ag/Pd alloy nanoparticles, a content of Pd (second metal) is 0.01-50% based on a total weight of metals (Ag+Pd). More preferably, the content is 0.05-50%. If the content of Pd is less than 0.01%, the vaporization occurs when a conductive wire is heat treated at 450° C. or higher, thus the adhesive power and conductivity of the wire may be significantly reduced. If the content of Pd is 0.01% or more, the vaporization is reduced or does not occur, and thermal stability of the conductive wire and adhesive power to the matrix are significantly increased as the Pd content is increased. Additionally, if the content of Pd is more than 50%, conductivity of the silver wire may be significantly reduced due to low conductivity of Pd. Accordingly, when the treatment is conducted at a high temperature of 450° C. or higher, it is preferable that 0.01-50% Pd be contained in views of thermal stability and conductivity.

As well, according to the present invention, the content of Pd, that is, the content of second metal, is controlled within a predetermined range to control conductivity and thermal stability required in final goods. In other words, if products require thermal stability rather than conductivity, the content of Pd is controlled to be increased.

The ink solution comprises the metal oxide nanoparticles (A), the partially poly-condensated metal oxides (B), and the metal nanoparticles (C), and dispersing agent and the solvent.

The dispersing agent used in the solution is selected from organics having functional groups capable of forming complexes on a surface of metal, and may be exemplified by alkylamine, carboxylic acid amide, aminocarboxylate, and sodium citrate. In connection with this, an alkyl group of alkylamine has a carbon number of 4-20, preferably 4-12, thus sufficiently dispersing the metal nanoparticles (C) in a non-polar solvent. Furthermore, polyvinylpyrrolidone (PVP) having a molecular weight (Mw) of 1,000-40,000, preferably 10,000-20,000, or polyvinyl alcohol having a molecular weight (Mw) of 1,000-40,000, preferably 10,000-20,000, may be used. Additionally, any one or a mixture of two or more selected from the group consisting of commercial dispersing agents, such as BYK-108, BYK-1000, or BYK-antiterra-U manufactured by BYK Co. of Germany, may be used.

The solvent of the dispersing solution (D) may be at least one selected from solvents, such as nonpolar hydrocarbons having a carbon number of 6-20, water, cellosolve-based alcohol, or polar alcohol, according to physical properties of a surfactant for reforming surfaces of the metal nanoparticles (C).

A metal nanoparticle-dispersed solution is produced, and powder of the metal oxide nanoparticles (A) and/or the partial polycondensation metal oxides (B), or a dispersing solution thereof is mixed therewith to be dispersed therein, thereby producing the metallic ink of the present invention. The metal nanoparticle-dispersed solution may be produced through a known method. Preferably, the production is conducted using a liquid phase reduction method. In connection with this, during the production, a content of solids is set to 1-70%, preferably 10-55%, based on a total weight of ink so that viscosity is 1-100 mPa-s, preferably 1-50 mPa-s, and that a surface tension is 25-80 mN/m, preferably 30-60 mN/m. Accordingly, it is possible to satisfy ink characteristics capable of realizing patterning using an inkjet printer.

The metallic ink of the present invention as described above is used to form a conductive wire on a substrate, such as plastics constituting various electronic goods, such as substrates (plastic or glass) for producing electrodes of various panels including PDPs, mobile communication terminals, and home appliances, or to obtain metallic texture of the matrix through various printing methods. Particularly, it is useful to produce electrodes, such as in the PDPs.

Meanwhile, a method of forming electrodes according to the present invention comprises printing the above-mentioned metallic ink on a side (any one side or both sides of the substrates) of a substrate which is selected from the plastic and glass substrates one or more times to form a conductive wire. In connection with this, the conductive wire is patterned using an inkjet printing process, and heat is then applied to conduct a heat treatment process. The heat treatment process may be conducted at a temperature of 60° C. or higher. Preferably, the heat treatment is conducted at a temperature of 120° C. or higher, particularly, 120-650° C., and more preferably, it is conducted at a high temperature of 450° C. or higher, particularly, 450-650° C. As described above, if the heat treatment is conducted at high temperatures, conductivity as well as adhesive powder is improved.

Furthermore, in a substrate according to the present invention, electrodes (conductive wires) are formed on a substrate using the above-mentioned method for forming the electrodes, and it is usefully applied to electrodes of various electronic products, such as PDP or semiconductor devices.

A better understanding of the present invention may be obtained through the following examples and comparative examples which are set forth to illustrate, but are not to be construed as the limit of the present invention.

### EXAMPLE 1

### (1) Production of an Ag Nanoparticle-Dispersed Solution

236.247 g of AgNO was dissolved in water distilled three times to produce a metal compound aqueous solution having a metal concentration of 30% (a weight ratio of metal in a solution). Next, polyvinylpyrrolidone (PVP, Mw=40,000) was added in a content of 10% (Ag:PVP=0.1:1) based on a weight of metal in a nitrogen atmosphere, and agitated until complete dissolution. A temperature of the solution was maintained at 60° C. 4 L of mixed solution of ethanol and decane (2:8 ratio) was added to the resulting solution and then mixed therewith. Subsequently, 2 moles of potassium borohydride were added as reducing agent to conduct metal reduction reaction, thereby producing Ag nanoparticle-dispersed solution. Additionally, BYK-108 (manufactured by BYK, Co. of Germany) and PVP were added to the solution. After the reduction reaction was conducted as described above, the amount of solution was about 6 L, and Ag nanoparticles were uniformly dispersed therein. Subsequently, ethanol was added to change polarity so as to separate Ag nanoparticle powder from the dispersed solution. As well, washing was conducted using distilled water and acetone a few times to remove impurities. The particles, which were recovered through the washing process, were dispersed using a solvent mixed with hydrocarbons, including hexane, decane, and toluene. In connection with this, the Ag nanoparticles had a particle size of about 3-7 nm, and were uniformly dispersed in the solvent while the particles were completely isolated from each other. The dispersed solution contained 53.4 wt % Ag nanoparticles based on the total weight thereof, and viscosity was 8.7 mPa-s, at which inkjet patterning was capable of being conducted, at 25° C. Furthermore, it was confirmed that the Ag ultrafine particle dispersed-solution thus produced was stable without precipitation at normal temperature even after 30 days.

### (2) Production of a Pd Nanoparticle Dispersed-Solution

The above-mentioned procedure of producing the Ag nanoparticle-dispersed solution was repeated to produce an ultrafine Pd particle-dispersed solution except that Pd(NO) was used. In connection with this, ultrafine Pd particles had a particle size of about 5-10 nm, and were uniformly dispersed in a solvent while the particles were completely isolated from each other. The dispersed solution contained 45 wt % Pd nanoparticles based on the total weight thereof, and viscosity was 13.4 mPa-s at 25° C. Furthermore, it was confirmed that the ultrafine Ag particle-dispersed solution thus produced was stable without precipitation at normal temperature even after 30 days.

### (3) Production of an Ink

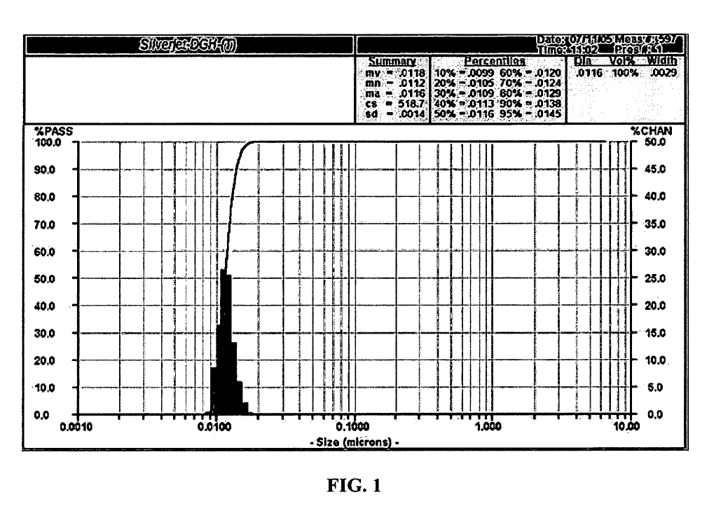

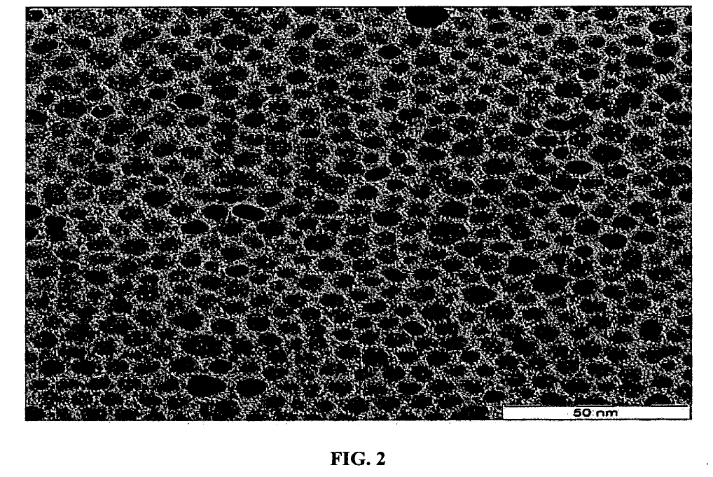

The Ag nanoparticle-dispersed solution and the Pd nanoparticle dispersed-solution were mixed with each other so that the content of Pd was 0.3% based on a weight of metal (Ag+Pd). FIG. 1 is a graph showing a particle size distribution of a Ag/Pd nanoparticle-dispersed solution, which is measured using a particle size analyzer (UPA-150 manufactured by Microtek, Inc. of Japan), and FIG. 2 is a TEM picture of the Ag/Pd nanoparticle-dispersed solution. From FIGS. 1 and 2, it was confirmed that metal particles were uniformly dispersed while they were not agglomerated, but completely isolated from each other.

Subsequently, a silica sol (manufactured by Nissan Chemical Industries, Ltd. of Japan, commercial name: Snowtex), with which silica having a diameter less than 50 nm was mixed, was added to the resulting mixed solution in the amount of 3% based on a weight of Ag and Pd metal solids (Ag+Pd) to produce an inkjet ink. An ultrafine inkjet metal particle-dispersed solution was produced.

### (4) Production of a Specimen

The ink thus produced was patterned on a glass substrate for PDP application using a 70 system, which was an inkjet model manufactured by Litrex, Corp. of the USA and was equipped with a spectra SE head manufactured by Spectra, Inc. of the USA. In the course of forming a wire through the inkjet patterning, printing was repeated twice to obtain a wire having a total length of 1160 mm and a thickness of 70-90 D. The ink was effectively discharged without clogging the nozzle and then patterned. A picture of the Ag/Pd metal wire formed through the inkjet patterning is shown in FIG. 3.

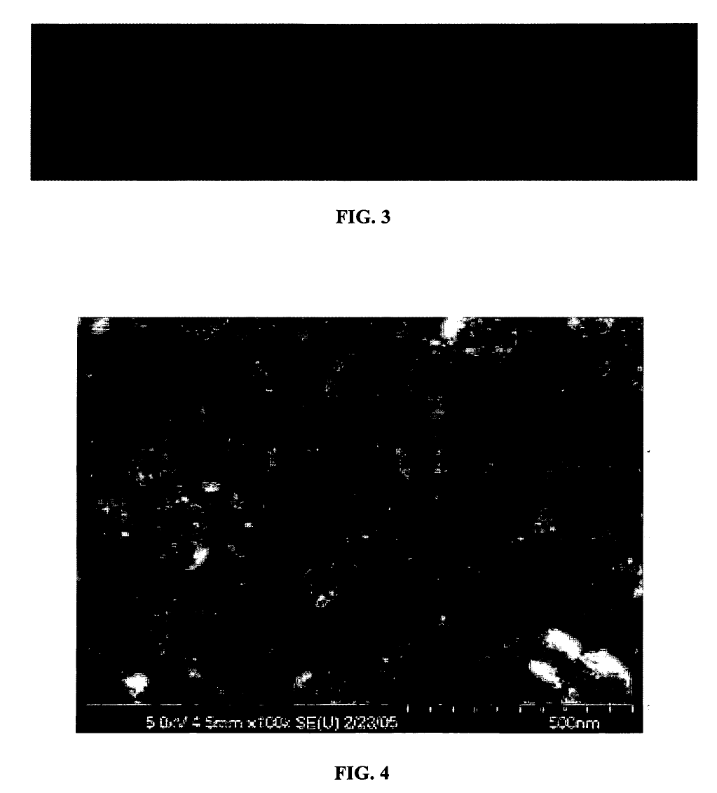

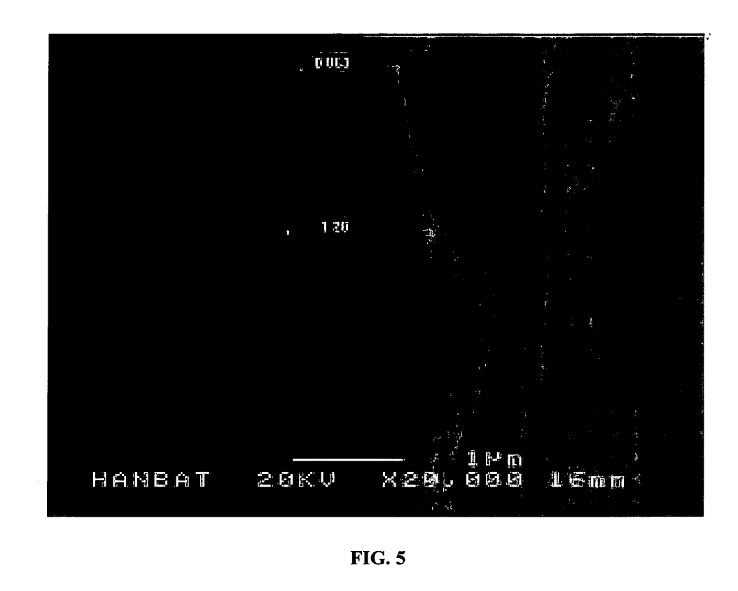

Subsequently, the patterned metal wire was heat treated at 250° C. and at 560° C. to produce a specimen according to the present example. In connection with this, heat was applied at 250° C. for 30 min, and at 560° C. for 20 min. FIG. 4 is a SEM picture of the metal wire heat treated at 250° C., and FIG. 5 is a SEM picture of the metal wire heat treated at 560° C.

### (5) Evaluation of Adhesive Power, Conductivity, and Thermal Stability

Adhesive power, conductivity, and chemical stability of the resulting specimen were evaluated. After a 3M tape (a pressure sensitive tape manufactured by 3M, Co. of the USA) was placed on the patterned/heat treated metal wire and the tape was peeled off. Damage to the wire due to removal of the tape therefrom was observed with the naked eye to evaluate the adhesive power. The conductivity was measured using a 4-point probe tester manufactured by Mitsubishi Co. in Japan. Additionally, light trans-mittances of the specimen were comparatively measured before and after the patterning/heat treatment to evaluate metal vaporization occurred at high temperature treatment.

The results are described in the following Tables 1 and 2.

### EXAMPLES 2 TO 5

The procedure of example 1 was repeated except that an Ag nanoparticle-dispersed solution and a Pd nanoparticle dispersed-solution were mixed so that a Pd content was 1% (example 2), 5% (example 3), 10% (example 4), and 30% (example 5) during the production of ink. The results are described in the following Tables 1 and 2.

### EXAMPLE 6

The procedure of example 1 was repeated except that a Pd nanoparticle dispersed-solution was not used during the production of Pd. An ink of the present example comprised an Ag nanoparticle-dispersed solution and a silica sol, and was effectively discharged without clogging of a nozzle during inkjet patterning to form a metal wire. However, metal particles were vaporized when they were heat treated at a high temperature of 560° C. In this case, desirable conductivity was not obtained. Thus, it can be seen that it is difficult to use the high temperature heat treatment. The results are described in the following Tables 1 and 2.

### EXAMPLES 7 TO 9

The procedure of example 1 was repeated except that a silica sol was not used during the production of ink. In other words, each of inks of the present examples comprised an Ag nanoparticle-dispersed solution and a Pd nanoparticle dispersed-solution. In connection with this, the production of inks was conducted so that the Pd content was 0.3% (example 7), 5% (example 8), and 30% (example 9) in metals (Ag+Pd). It was confirmed that the inks were effectively discharged without clogging of a nozzle during inkjet patterning to form a metal wire. Furthermore, it was confirmed that vaporization did not occur during heat treatment of 560° C. and neither at a heat treatment of 250° C. The results are described in the following Tables 1 and 2.

### EXAMPLE 10

First, Ag nanoparticles were produced through the same procedure as example 1.

[104] Then, 20 g of hexyltrimethoxysilane (manufactured by Toshiba Chemical, Corp. of Japan; commercial name: TSL8241) was added to 20 g of teraethoxysilane (TEOS manufactured by Toshiba Chemical, Corp. of Japan; commercial name: TSL8124) and agitation was sufficiently conducted. 20 g of dodecane was added thereto, and 10 g of sodium hydroxide aqueous solution (20 wt % aqueous solution) was then added. A ball milling process was conducted at room temperature to produce a partial condensate of silica. After a water layer was removed, the partial condensate of silica in an organic layer was concentrated to be 30 wt % on a dry basis. It was confirmed that the partial condensate of silica was uniformly dispersed in a solvent.

Subsequently, the partial condensate of silica was added to ultrafine Ag particle powder in the amount of 3% based on metal, and agitation and dispersion were conducted using a tetradecane solvent. The dispersed solution contained 52.3 wt % Ag metal, and viscosity was 11.4 mPa-s at 25° C. The dispersed solution was subjected to an inkjet patterning process through the same procedure as example 1, and heat treatment was conducted at 250° C. and at 560° C. to form a metal wire. In connection with this, metal particles were vaporized while the heat treatment was conducted at a high temperature of 560° C. In this case, desirable conductivity was not obtained. Thus, it can be seen that it is difficult to use the high temperature heat treatment. The results are described in the following Tables 1 and 2.

### EXAMPLE 11

After a partial condensate of silica was produced through the same procedure as example 10, it was added to Ag nanoparticle powder and Pd nanoparticle powder, which were produced through the same procedure as example 1, in the amount of 3 wt %, and agitation and dispersion were conducted using tetradecane as a dispersing solvent. The dispersed solution contained 51.8 wt % Ag/Pd metals, and viscosity was 13.4 mPa-s at 25° C. Additionally, Pd was contained in a weight ratio of 0.5% based on all metals. The dispersed solution was subjected to an inkjet patterning process through the same procedure as example 1, and heat treatment was conducted at 250° C. and at 560° C. to form a metal wire. The results are described in the following Tables 1 and 2.

### COMPARATIVE EXAMPLE 1

After ultrafine Ag particle powder was produced through the same procedure as example 1, it was uniformly agitated and dispersed in a tetradecane solvent to produce an Ag metal ink. The Ag ink contained 54 wt % Ag, and viscosity was 9.3 mPa-s at 25° C. Additionally, after the ink was subjected to an inkjet patterning process through the same procedure as example 1, heat treatment was conducted at 250° C. and at 560° C. to form a metal wire, and its physical properties were compared to those of the above-mentioned examples. In a specimen according to the present comparative example, the metal wire was uniformly formed on a glass substrate without clogging the nozzle during the patterning process. However, it was confirmed that desired conductivity was not obtained due to vaporization during the high-temperature heat treatment of 560° C. With respect to adhesive power, from the tape test results, it was confirmed that a detachment ratio of 80% or more was obtained. The results are described in the following Tables 1 and 2.

TABLE 1
Evaluation of adhesive power and conductivity of metal wire

| | | 250° C. * 30 min | | 560° C. * 20 min | |
|---|---|---|---|---|---|
| | | Specific | | Specific | |
| | | resistance | Adhesive | resistance | Adhesive |
| Section | Metal ratio | (1 × 10⁻⁶Ω · m) | power | (1 × 10⁻⁶Ω · m) | power |
| Example 1 | Ag/Pd(99.7/0.3)s | 8.98 | Δ | 3.54 | ⊚ |
| Example 2 | Ag/Pd(99/1)s | 10.4 | ◯ | 3.87 | ⊚ |
| Example 3 | Ag/Pd(95/5)s | 17.6 | ◯ | 5.08 | ⊚ |
| Example 4 | Ag/Pd(90/10)s | 28.6 | ◯ | 8.5 | ⊚ |
| Example 5 | Ag/Pd(70/30)s | 86.5 | ◯ | 40.3 | ⊚ |
| Example 6 | Ag 100%s | 4.85 | ◯ | Impossible to | X |
| | | | | measure | |
| Example 7 | Ag/Pd(99.7/0.3) | 4.98 | X | 3.64 | Δ |
| Example 8 | Ag/Pd(95/5) | 9.75 | X | 4.97 | Δ |
| Example 9 | Ag/Pd(70/30) | 60.3 | X | 42.5 | ⊚ |
| Example 10 | Ag 100% | 4.9 | Δ | Impossible to | ⊚ |
| | cond.s | | | measure | |
| Example 11 | Ag/Pd(99.5/0.5) | 5.56 | Δ | 4.01 | ⊚ |
| | cond.s | | | | |
| Co.Ex.1 | Ag 100% | 4.5 | X | Impossible to | X |
| | | | | measure | |

In the evaluation of adhesive power as shown in Table 1, 80% or more detachment, 10-20% detachment, detachment of less than 10%, and no detachment were designated by X, Δ, ◯, and \textcircled{•}, respectively.

TABLE 2
Evaluation of transmission and thermal stability of metal wire

| | | 250° C. * 30 min | | 560° C. * 20 min | |
|---|---|---|---|---|---|
| | | Transmission | Thermal | Transmission | Thermal |
| Section | Metal ratio | (%) | stability | (%) | stability |
| Example 1 | Ag/Pd(99.7/0.3)s | 9.5 | Fair | 11.8 | Fair |
| Example 2 | Ag/Pd(99/1)s | 9.3 | Fair | 11.7 | Fair |
| Example 3 | Ag/Pd(95/5)s | 8.5 | Fair | 11.4 | Fair |
| Example 4 | Ag/Pd(90/10)s | 8.6 | Fair | 10.8 | Fair |
| Example 5 | Ag/Pd(70/30)s | 7.9 | Fair | 9.7 | Fair |
| Example 6 | Ag 100%s | 9.6 | Fair | 44.5 | Vaporization |
| Example 7 | Ag/Pd(99.7/0.3) | 9.4 | Fair | 11.5 | Fair |
| Example 8 | Ag/Pd(95/5) | 8.7 | Fair | 11.3 | Fair |
| Example 9 | Ag/Pd(70/30) | 7.6 | Fair | 9.6 | Fair |
| Example 10 | Ag 100% cond.s | 9.4 | Fair | 45.4 | Vaporization |
| Example 11 | Ag/Pd(99.5/0.5)cond.s | 9.4 | Fair | 11.3 | Fair |
| Co.Ex.1 | Ag 100% | 9.3 | Fair | 50.2 | Vaporization |

In Tables 1 and 2, “S” denotes silica, and “Cond. S” denotes a partial condensate of silica.

As shown in Table 1, it can be seen that adhesive powers of the examples according to the present invention are significantly improved in comparison with that of the comparative example. Furthermore, from the comparison of the results of examples 1 to 5 and examples 7 to 9, it can be seen that the adhesive power is high at a low temperature of 250° C. when metal oxide nanoparticles or partial condensation metal oxides are added (examples 1 to 5) in comparison with the case in which they are not added (examples 7 to 9). Furthermore, from the results of examples 1 to 5, it can be seen that, if heat treatment is conducted at a high temperature, the adhesive power and conductivity are simultaneously improved. As well, from the comparison of the results of example 9 and comparative example 1, it can be seen that if Pd is contained at a high proportion and if the heat treatment is conducted at a high temperature as shown in example 9, excellent adhesive power is obtained even though the metal oxide nanoparticles or the partial condensation metal oxides are not added.

Additionally, as shown in Table 2, it can be seen that, since thermal stability is excellent, vaporization does not occur at a high temperature of 560° C. when metal nanoparticles include an alloy (Ag/Pd) (examples 1 to 5, 7 to 9, and 11), in comparison with the case in which they consist of a single metal (examples 6 and 10, and comparative example 1).

The present invention is useful for the electronic industry. Particularly, it is useful to form a conductive wire or to obtain metallic texture in the production of electrodes of various panels, such as a PDP, and various electronic parts, such as mobile communication terminals.

The present invention is advantageous in that it is possible to conduct patterning using an inkjet printer and adhesive power to a matrix is improved due to metal oxide nanoparticles and partial poly condensation metal oxides. Furthermore, the present invention is advantageous in that vaporization is avoided, thus it is possible to conduct heat treatment at high temperatures, thereby improving adhesive power and conductivity.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A metallic ink, comprising:
at least one oxide selected from metal oxide nanoparticles and partially poly-condensated metal oxides having a size of 100 nm or less; and
metal nanoparticles having a size of 100 nm or less, wherein the oxides and the metal nanoparticles are dispersed as isolated ultrafine particles in solvent.

2. The metallic ink of claim 1, wherein the metal oxide nanoparticles are any one or a mixture of two or more selected from a group consisting of oxides of silicon (Si), magnesium (Mg), yttrium (Y), cerium (Ce), titanium (Ti), zirconium (Zr), vanadium (V), chromium (Cr), manganese (Mn), iron (Fe), cobalt (Co), nickel (Ni), neodymium (Nd), copper (Cu), silver (Ag), zinc (Zn), aluminum (Al), gallium (Ga), indium (In), tin (Sn), and antimony (Sb).

3. The metallic ink of claim 1, wherein the partially polycondensated metal oxides are inorganic polycondensate polymers expressed by the following formula:
M_{X}O_{Y}(OR)_{Z}
wherein M is selected from the group consisting of: Si, Mg, Y, Ce, Ti, Zr, V, Cr, Mn, Fe, Co, Ni, Nd, Cu, Ag, Zn, Al, Ga, In, Sn, and Sb; R is hydrogen or a hydrocarbon; and x, y, and z are integers or decimals larger than 0.

4. The metallic ink of claim 1, wherein each of the metal nanoparticles is:
an alloy of a first metal, having high conductivity, and a second metal, which forms the alloy along with the first metal to provide thermal stability; or
a mixture of the first and the second metal particles.

5. The metallic ink of claim 4, wherein the metal nanoparticles include from 0.01% to 50% of a second metal, based on the weight of the metals.

6. The metallic ink of claim 4, wherein:
the first metal is selected from the group consisting: of silver (Ag), gold (Au), platinum (Pt), and copper (Cu); and
the second metal is selected from a group consisting of palladium (Pd) and nickel (Ni).

7. The metallic ink of claim 5, wherein:
the first metal is selected from the group consisting: of silver (Ag), gold (Au), platinum (Pt), and copper (Cu); and
the second metal is selected from a group consisting of palladium (Pd) and nickel (Ni).

8. A metallic ink, wherein metal nanoparticles having size of 100 nm or less are dispersed as isolated ultrafine particles in solvent, each metal nanoparticle being an alloy of a first metal, having high conductivity, and a second metal, which forms the alloy along with the first metal to provide thermal stability, or being a mixture of the first and the second metal particles.

9. The metallic ink of claim 8, wherein the metal nanoparticles include from 0.01% to 50% of the second metal, based on the weight of the metals.

10. The metallic ink of claim 8, wherein:
the first metal is selected from the group consisting of: silver (Ag), gold (Au), platinum (Pt), and copper (Cu); and
the second metal is selected from the group consisting of palladium (Pd) and nickel (Ni).

11. The metallic ink of claim 9, wherein:
the first metal is selected from the group consisting of: silver (Ag), gold (Au), platinum (Pt), and copper (Cu); and
the second metal is selected from the group consisting of palladium (Pd) and nickel (Ni).

12. A method of forming electrodes, the method comprising:
producing a metallic ink, the metallic ink including:
at least one oxide selected from metal oxide nanoparticles and partially polycondensated metal oxides having a size of 100 nm or less; and
metal nanoparticles having a size of 100 nm or less, the oxides and the metal nanoparticles being independently dispersed in a solvent;
patterning the metallic ink on a matrix using an inkjet printer; and
heat treating the patterned metallic ink.

13. The method of claim 12, wherein the heat treating is conducted at 60-650° C.

14. A method of forming electrodes, the method comprising:
producing a metallic ink, the metallic ink including metal nanoparticles having a size of 100 nm or less, the metal nanoparticles being dispersed as isolated ultrafine particles in solvent, the metal nanoparticles each:
being an alloy of a first metal, having high conductivity, and a second metal, which forms the alloy along with the first metal to provide thermal stability, or
being a mixture of the first and the second metal particles;
patterning the metallic ink on substrates using an inkjet printer; and
heat treating the patterned metallic ink.

15. The method of claim 14, wherein the step of heat treating the patterned metallic ink is conducted at from 450° C. to 650° C.

16. A substrate on which electrodes are formed according to the method of claim 12.

17. A substrate on which electrodes are formed according to any one of claim 14.
